(19) United States
(12) Patent Application Publication
(10) Pub. No.: US 2015/0325061 A1
(43) Pub. Date: Nov. 12, 2015

(54) Vehicle having an electronically controlled vehicle device that can be operated by a driver

(71) Applicant: Siemens Aktiengesellschaft, Muenchen (DE)

(72) Inventors: Frank GERSTENBERG, Berlin (DE); Sebastian GERSTENBERG, Berlin (DE); Göran KEIL, Berlin (DE); Michael LEHMANN, Erlangen (DE)

(21) Appl. No.: 14/410,179

(22) PCT Filed: Jun. 6, 2013
(86) PCT No.: PCT/EP2013/061641

§ 371 Date: Dec. 22, 2014

(30) Foreign Application Priority Data
Jun. 21, 2012 (DE) 10 2012 210 519.0

(51) Int. Cl. G07C 5/00; B60R 16/023

(52) U.S. Cl. CPC G07C 5/008; B60R 16/0231

(57) ABSTRACT

A vehicle has a cab for a driver. An electronically controlled vehicle device, in particular a current collector, can be operated by the driver. An operating device has an input to receive from the driver an operating command and an output for outputting a status indication to the driver. A control device outside the cab produces a control signal for the vehicle device from the operating command and a status indication from a status signal of the vehicle device. The control device is connected to the vehicle device and the operating device by way of a network for data transmission. The operating device is portable and can be fixed in a retaining device, which has a network interface and is arranged in the cab, for operation during travel. It can be detached from the retaining device in order to be carried by the driver.

The invention relates to a vehicle, in particular a truck driven by electrical or diesel-electrical power, having an electronically-controlled vehicle device that can be operated by a driver, in particular a current collector.

Many vehicle devices—for instance driver assistance systems, such as route guidance systems for example, or vehicle structures, such as roll-on/roll-off containers for example—are controlled by an electronic control device and operated by the driver by means of an operating device. The control device is connected to the operating device and to the vehicle device to be controlled by way of a network for the purpose of data transmission. By way of the operating device, the driver of a vehicle is also intended to be able to input commands to operate the vehicle device during travel, and also to obtain indications about the status of the vehicle device.

Small control devices with any installation location can be arranged in the driver's cab close to the operating device or embodied therewith in a device unit to enable its operation by the driver during travel. Control devices that exceed a certain size or have a functionally predetermined installation location sometimes cannot be arranged in the driver's cab. In such cases special operating elements such as switches and buttons are integrated in a fixed manner in the cabin console, and either existing display screens are used for status indications or special signaling elements such as light-emitting diodes are integrated in a fixed manner in the cabin console. These are inflexible special solutions involving high outlay on installation.

The object of the invention is therefore to provide, in a vehicle having an electronically-controlled vehicle device that can be operated by a driver including a control device arranged outside of a driver's cab, an operating device that is flexible and can be integrated easily into the driver's cab for operation of the vehicle device during travel.

The object is achieved according to the invention by means of a vehicle having the features disclosed in claim 1, according to which a vehicle has a driver's cab for a driver. Furthermore it has an electronically-controlled vehicle device that can be operated by the driver. It also has an operating device having input means for the input of an operating command by the driver and output means for the output of a status indication to the driver. The vehicle additionally has a control device arranged outside the driver's cab that is designed to produce a control signal for the vehicle device from the operating command and to produce the status indication from a status signal of the vehicle device. It also has a network for the purpose of data transmission that connects the control device with the vehicle device and the operating device. The operating device is designed here to be portable, can be fixed in a retaining device, which has a network interface and is arranged in the driver's cab, for operation during travel, and can be detached from the retaining device in order to be carried by the driver. With a significant cost advantage for the operating device it can be attached to platforms for known mobile communication devices, in particular for what are known as smartphones, for which retaining devices are also available—e.g. with a suction cup for affixing to a windshield of the driver's cab or thereunder by means of clamps to the cabin console. For connection to the network the retaining device as a hard-wired network interface can be assigned either a wirelessly integrated plug connection or one that is accessible separately via a connecting cable. Operating devices embodied in such a manner are easily portable and flexible in use—for example in different vehicles with comparable vehicle devices. For operation of the vehicle device also during travel, the driver places the operating device in the retaining device and connects it to the control device by way of the network interface. The driver just as easily removes the operating device from the retaining device and can carry it with him when leaving the driver's cab. The flexibility of the operating device can be increased by integrating further functions that are known from smart phone technology.

In an advantageous embodiment of the inventive vehicle the status signal has one of many operating statuses that are each assigned to one operating command, or a fault status, of the vehicle device. If during operation for example different positioning movements can be executed by the vehicle device that can be initiated through the input of assigned operating commands into the operating device and can be controlled by the control device producing corresponding control signals, the driver can receive confirmation that the particular positioning movement has been executed through the output of a corresponding status indication on the operating device. If there is a fault in the control device or in the vehicle device that impedes the initiation of a positioning movement for which a command has been given, the driver can also be notified of this through a corresponding status indication on the operating device. In this way the driver is informed at all times about the present status of the vehicle device and can, if necessary, take steps to eliminate a reported fault at an early stage.

In a preferred embodiment of the inventive vehicle the operating device has input and/or output means embodied as a touch screen, a wireless network interface and/or a hard-wired network interface, and computing means that interact with the touch screen and a network interface, with an operating program being capable of execution on the computing means for the input of operating commands and for the output of status indications. Despite its compactness, an operating device based on what is known as a smartphone has user-friendly input/output means in the form of a high-contrast touch screen that can take up a large proportion of an operating device housing. In this way the touch screen can be controlled by the computing means to present command input fields and status output fields. To this end an operating program is executed by the computing means, in other words an application software programmed for operation of the respective vehicle device. This allows a high degree of flexibility to be achieved in the functional and graphical implementation of the operating and indicating functions. To make adjustments for new functions, it is only necessary to update the operating program accordingly. This can be performed with minimal outlay from a central point via the wireless network interface of the operating device. The operating program makes it possible to communicate, by way of a data protocol to be defined, with the electronic control device via the network interface. The advantage of the high level of user acceptance for smartphones is not inconsiderable, not least because of their agreeable design.

In an advantageous embodiment of the inventive vehicle the operating device has navigation means for satellite-aided vehicle navigation and/or radio telephony means for cellular mobile radio communication. Previously separately installed or connectable navigation devices or mobile communication devices in vehicles can be integrated advantageously into the inventive operating device. For this purpose a receiving module for signals of a global, satellite-aided position determination system is to be integrated, access to digital road maps is to be established, and a guidance program that interacts with these is to be executed on the computing means. Furthermore a loudspeaker and a microphone are to be integrated into the operating device for radio telephony, and a program for transmitting radio telephony, text and image data by way of the wireless network interface are to be executed on the computing means. The position signals received by a satellite system can be used for example also in conjunction with further sensor signals as input signals for a lane-keeping system for high-precision lane-keeping for the vehicle.

In a preferred embodiment the inventive vehicle has an electric traction drive, with the vehicle device being embodied as a current collector with positionable collector shoes, which for the purpose of feeding in electrical energy during travel can be brought into sliding contact with a contact line of a wayside contact line system, and with the current collector having positioning means that can be controlled by the control device, for establishing or interrupting the sliding contact. In this embodiment trucks for example with a diesel-electric traction drive can be supplied with electrical energy, during travel over large sections of a route, from contact wires of an overhead line system. Through positioning means embodied as a raising and lowering mechanism, a current collector disposed on the upper side of the vehicle can be raised and lowered in order to bring its collector shoes into contact with the contact wires or to interrupt said contact. If for instance the vehicle drives into a lane with an overhead line system, during travel the driver inputs into the operating device the command to raise the current collector as well as, when leaving said lane, including for overtaking or evasive maneuvers, the command to lower the current collector. In response, the operating device outputs the relevant operating status “Raising” or “Lowering” of the current collector as a status indication for the driver. If the control device registers a fault and the current collector cannot or may not be raised, this also appears on the operating device as a status indication.

Furthermore the vehicle device of the inventive vehicle preferably has sensor means for acquiring a height and/or a lateral position of the collector strips relative to the contact line, wherein the status signal shows the acquired height and/or lateral position. For example by means of inductive or optical sensor means, the present height and lateral position of the collector shoes of the current collector, relative to the contact wires of an overhead line system embodied as conductor pairs, can be acquired. By way of a status indication of the present height, the driver can monitor on the operating device the effect of the operating commands he has input. The vehicle is to be steered, on the one hand, in such a way that the contact between collector shoes and contact wires is not interrupted during travel, and on the other hand in such a way that there is even wear on the work surface of the collector shoes. By means of a status indication as to the relative lateral position, in other words a deviation in a center of a collector shoe from a center of a contact line as measured across the direction of travel, the driver can perform compensatory manual steering interventions with the aid of the operating device. Automatic steering interventions can also be performed by a lane-keeping system, to which the sensor signals with the present lateral position and the position signals from navigation means can be supplied as input signals. The object of achieving even wear with the retention of a secure contact of the contact elements during travel may be improved as a result of the positioning means of the current collector also allowing a lateral positioning movement to be performed.

In a further advantageous embodiment the inventive vehicle has an inspection device that is intended to be operated by an inspector of the contact line system, which is embodied so as to refuse or allow, in a communications link with the control device, the establishment of a contact between the current collector and the contact line. It is in the interest of the operator of a contact line system to allow a contact with the contact line to be established only by vehicles for which there exists an energy supply authorization—subject to the payment of a fee—and for which the current collectors display the requisite technical operational readiness, in particular collector shoes for which the wear limits have not yet been exceeded. To this end the inspector can perform an on-board diagnosis by means of a visual inspection, and depending on the outcome can decide whether he allows or refuses the establishment of a contact by the current collector. To this end, using control panels of the inspection device that is also embodied as a smartphone, he can input his decision, which is transmitted via wireless network interface to the control device of the vehicle being inspected and is output there by the operating device as a status notification. If the decision is a refusal, the control device blocks the positioning movement to raise the current collector.

By means of the inspection device of the inventive vehicle, a diagnosis of the technical operational readiness of the current collector can preferably be queried in the control device. To this end the current collector has means, in automatic cooperation with the control device, of performing a diagnosis of the operational readiness of the current collector, in particular to determine the state of wear of its contact elements. In a wireless communications link a remote diagnosis can also be performed from a control center of the contact line system with the aid of the inspection device, and the resulting decision of the inspector can be implemented.

In another preferred embodiment of the inventive vehicle it is possible, by means of the inspection device, to query with a control center of the contact line system whether an energy supply authorization exists for the vehicle. If the inspector is at the vehicle, he can determine the supply authorization, upon which he will also base his decision, by means of a wireless remote query to the control center.

In a further embodiment of the inventive vehicle the inspection device has image recording means for digital imaging and is embodied so as to store, in storage means, documentation data regarding the queried diagnosis and/or the images recorded, together with the inspector's decision. For warranty purposes the operator of a contact line system has an interest in documenting the decisions of its inspectors. To this end, by means of the inspection device the inspector can record digital images at an on-board diagnosis that provide evidence of inadequate or absent operational readiness of the current collector. With remote diagnosis, the diagnostic report queried is available to him in digital form. This vehicle-specific documentation data is stored together with the result and the time of his decision in storage means of the inspection device or transmitted to the control center for storage in storage means.

Further properties and advantages of an inventive vehicle will emerge from the following description of an exemplary embodiment with the aid of the drawings, in which

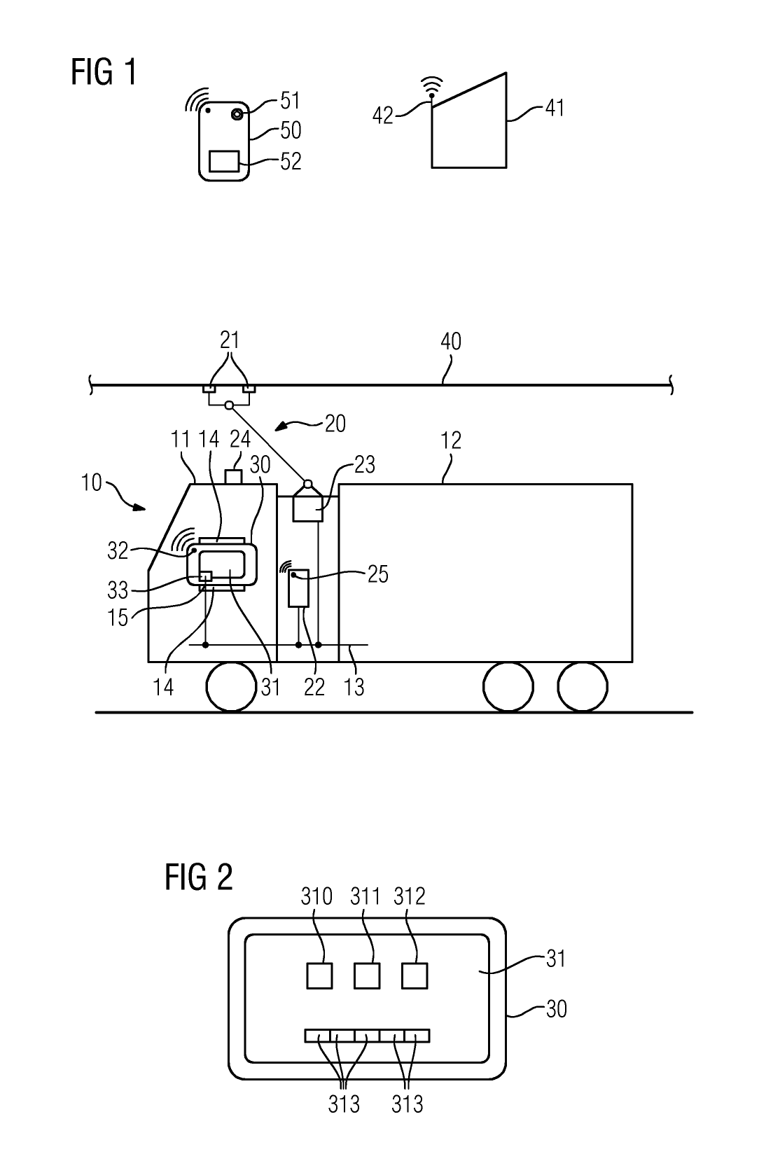

FIG. 1 shows an inventive vehicle, and

FIG. 2 shows an operating device for the vehicle device of the vehicle shown in FIG. 1 in schematic representation.

A vehicle 10 according to FIG. 1 is embodied as a truck with an electric or diesel-electric traction drive and has, in a per se known manner, a driver's cab 11 for a driver and a load body 12 as a transport space. Supported on an upper side of the vehicle is a vehicle device embodied as a current collector 20 for the purpose of feeding in electrical traction energy from a contact line system. The contact line system is embodied as a per se known overhead line system for the electrification of a lane of a highway. To this end conductor pairs of a bipolar contact line 40 extend in parallel at equal height above the lane. The per se known supporting and clamping devices for the contact line 40 are not shown. The energy supply is provided through the establishment of an electrical sliding contact between collector shoes 21 of the current collector 20 and the contact line 40. The current collector has a frame, at the contact-line end of which a rocker is disposed that is rotatable about a transverse axis of the vehicle. The rocker supports two pairs of strip-shaped collector shoes 21—with a pair arranged one behind the other in the direction of travel for each line pole. At its vehicle-side end, the frame of the current collector 20 is rotatably lowered such that the collector shoes 21 can perform a positioning movement that can be performed by means of positioning means 23. The positioning means 23 can be embodied as pneumatic raising and lowering actuators by means of which the current collector 20 can be lifted and the collector shoes 21 can be raised to establish a contact with the contact line 40 and lowered again to interrupt the contact. To perform a positioning movement the positioning means 23 are actuated by a control device 22 by way of control signals. Owing to the size of the control device 22 it is disposed outside of the driver's cab 11 and connected to the positioning means 23 of the current collector 20 by way of a network 13 for the purpose of data transmission, for instance a vehicle-side data bus.

In order that the current collector 20 can also be operated during travel by way of the control device 22, an operating device 30 is disposed in the driver's cab 11. The operating device 30 is embodied as a portable, compact smartphone. It can be detachably fixed, in particular clamped, in a retaining device 14 in the vicinity of a cabin console, and connected to the network 13 by way of a network interface 15, which is simultaneously embodied as a power supply connection. To this end the operating device 30 has a hard-wired network interface 33. The operating device 30 has input/output means embodied as a touch screen 31 that interact with computing means by way of an operating program running thereon.

In accordance with FIG. 2, the driver can input into the operating device 30, by means of touching, operating commands on command input fields 310, 311, 312 shown on the touch screen 31. For example, the command input field 310 for raising the current collector 20 and a command input field 311 for lowering the current collector 20 are available to him. From the operating commands, the control device 22 produces corresponding control signals for the positioning movement assigned to the operating command to be performed by the positioning means 23. Operating statuses are assigned to the positioning movements operated, which the current collector 20 feeds back to the control device 22 as a status signal. From this the control device 22 produces status indications for the operating device 30 that are made evident for example by means of colored highlighting of status output fields 313 shown on the touch screen 31.

Furthermore the vehicle 10 is assigned an inspection device 50 that can be operated by an inspector, which is likewise embodied as what is known as a smartphone, and which is connected to the control device 22 of a vehicle 10 by way of a wireless communication interface, as soon as the vehicle's driver has input an operating command to raise the current collector 20. Using the inspection device 50 the inspector then performs a diagnosis, which can be performed by means of a remote query, as to the operational readiness of the current collector 20, as well as a query to a control center 41 of the contact line system as to the presence of an energy supply authorization for the vehicle 10. If the collector shoes 21 of the current collector 20 are too heavily worn or if there is no valid energy supply authorization, the inspector refuses the establishment of a contact with the contact line 40. This decision is input into the inspection device 50 and transmitted wirelessly to the control device 22 of the vehicle 10. There, this decision causes the raise command input not to be able to be implemented by the control device 22 or causes a raise command performed to be reversed again forcibly—the current collector 20 is lowered. The decision effects a status indication in the operating device 30, for example by illuminating a status output field 313 that serves as an alert to the error. The driver can then acknowledge the error by means of touching the command input field 312.

Alternatively the inspector can perform an on-board diagnosis as to the technical operational readiness of the current collector 20 by means of a visual inspection. If he determines for example that the collector shoes 21 are too heavily worn, he registers this finding digitally by means of image recording means 51 integrated into the inspection device 50 and stores it together with his decision as documentation data in storage means 52 for documentation purposes. The documentation data can also be transmitted wirelessly for archiving, by way of a network interface 42 to the control center 41.

1-10. (canceled)

11. A vehicle, comprising:
a driver's cab for a driver;
an electronically controlled vehicle device to operated by the driver;
a portable operating device having an input for inputting an operating command by the driver and an output for outputting a status indication to the driver;
a control device disposed outside of said driver's cab and configured to produce a control signal for said vehicle device from the operating command and to produce the status indication from a status signal of said vehicle device;
a data transmission network for connecting said control device with said vehicle device and said operating device; and
a retaining device disposed in said driver's cab and having a network interface, wherein said portable operating device is configured to be fixed in said retaining device for operation during travel, and to be detached from said retaining device in order to be carried by the driver.

12. The vehicle according to claim 11, wherein the status signal has one of a plurality of operating statuses each assigned to one operating command, or a fault status, of the vehicle device.

13. The vehicle according to claim 11, wherein said operating device has an input and/or output device formed as a touch screen, at least one network interface selected from the group consisting of a wireless network interface and a hard-wired network interface, and a computing device configured to interact with said touch screen and a network interface, and wherein an operating program is configured for execution on said computing device for the input of operating commands and for the output of status indications.

14. The vehicle according to claim 11, wherein said operating device includes at least one of a navigation system for satellite-aided vehicle navigation or a radio telephony system for cellular mobile radio communication.

15. The vehicle according to claim 11, further comprising an electric traction drive, and wherein the vehicle device is a current collector with positionable collector shoes to be brought into sliding contact with a contact line of a wayside contact line system for the purpose of feeding in electrical energy during travel, and wherein said current collector has a positioning device to be controlled by said control device, for selectively establishing or interrupting the sliding contact.

16. The vehicle according to claim 15, wherein said vehicle device further has one or more sensors for acquiring at least one of a height or a lateral position of the collector shoes relative to the contact line, and wherein the status signal indicates at least one of the acquired height or the lateral position.

17. The vehicle according to claim 15, comprising an inspection device to be operated by an inspector of the contact line system and configured to selectively refuse or allow, in a communications link with said control device, an establishment of a contact between the current collector and the contact line.

18. The vehicle according to claim 17, wherein said inspection device is configured to query said control device regarding a diagnosis of the technical operational readiness of the current collector.

19. The vehicle according to claim 18, wherein said inspection device has an image recording system for digital imaging and storing, in a memory device, documentation data regarding the queried diagnosis and/or the images recorded, together with an inspector's decision.

20. The vehicle according to claim 17, wherein said inspection device is configured to query a control center of the contact line system whether an energy supply authorization exists for the vehicle.

21. The vehicle according to claim 20, wherein said inspection device has an image recording system for digital imaging and storing, in a memory device, documentation data regarding the queried diagnosis and/or the images recorded, together with an inspector's decision.
